(19) United States
(12) Patent Application Publication
(10) Pub. No.: US 2009/0181642 A1
(43) Pub. Date: Jul. 16, 2009

(54) PROFESSIONAL SERVICES TIME CAPTURING SYSTEM

(75) Inventor: Joseph Bekanich, Kingston, PA (US)

Correspondence Address: JOHN F. LETCHFORD, ARCHER & GREINER, P.C., ONE CENENNIAL SQUARE, HADDONFIELD, NJ, 08033, US

(73) Assignee: ADVANCED MOBILE TECHNOLOGIES, LLC, Dallas, PA (US)

(21) Appl. No.: 12/352,093

(22) Filed: Jan. 12, 2009

Related U.S. Application Data
(60) Provisional application No. 61/020,534, filed on Jan. 11, 2008.

(51) Int. Cl. H04M 15/00

(52) U.S. Cl. 455/406

(57) ABSTRACT

A system and method for capturing professional billing services and other information associated with a communication event executed or received by a stationary or portable computer or a mobile communications device. Captured information may include, without limitation, client/customer name, telephone number, email address, event start time, event end time, event billable time, amount charged for the event, billing rate, and notes/activities associated with the event. In addition, the invention enables customization of any or all of the foregoing by a professional services provider prior to issuance of a bill or invoice for professional services.

### CROSS REFERENCE TO RELATED APPLICATION

This application claims the benefit of U.S. Provisional Application No. 61/020,534, filed Jan. 11, 2008.

### FIELD OF THE INVENTION

The present invention relates in general to systems and methods for memorializing professional services activities and in particular to systems and methods for capturing time-related events performed by professional services providers.

### BACKGROUND OF THE INVENTION

Published United States Patent Application No. 2005/0043065 (“'065 application”), the disclosure of which is incorporated herein in its entirety by reference thereto, describes a system for monitoring, displaying and capturing billable and non-billable communications time usage data for professional services providers such as, for example, attorneys, independent contractors and engineers. In particular, the '065 application proposes capturing billable “call events” associated with cellular mobile communications devices such as cell phones, personal digital assistants (PDAs), and the like. The system proposed in the '065 application is presently commercially embodied by the Airtime-Manager® time management products marketed by Airtime-Manager, Inc. of Chevy Chase, Md.

Published U.S. Patent Application No. 2006/0019630 (“'930 application”) describes a system and method for supporting multiple wireless accounts (e.g., business and personal accounts) for a given subscriber. In some embodiments of the '930 application, the user may key-in or otherwise input an account code identifying the appropriate account to be billed for a “call type”. The code could include, for example, numbers, letters, words, phrases, utterances, some other account identification and/or a combination thereof. In other embodiments, the system may operate in a near-automatic mode—making its own decisions about what account code to apply to a call type based on, for example, location or the device address of the other party. In such an embodiment, the system may allow for user override of the system's presumed account coding decisions. A call type (or, more generally, “communication event”) may include, for example, a wireless cell phone call, an email message, an instant messaging message, a voice over internet protocol (“VOIP”) call.

While enabling a user to automatically or manually select an account to which a call type is to be applied, the '930 application does not permit a user to associate notes or client and/or matter identifiers with the communication event, charge professional billing services rates to the communication event, change those billing rates or otherwise customize a communication event billing entry.

Published U.S. Patent Application Nos. 2007/0208851; 2007/0274293; 2008/0066184 and 2008/0214143, as well as U.S. Pat. Nos. 6,917,601; 6,920,208; 7,298,833; 7,295,836; 7,305,082 and 7,324,505 disclose various systems and methods for monitoring, managing, archiving and/or analyzing communication events. However, like the '065 and '930 applications, none of these documents disclose the concept of enabling a user to associate notes or client/matter identifiers with a communication event, charge professional billing services rates to the communication event, change those billing rates or otherwise customize a billing entry corresponding to a communication event.

It is also common in today's legal market for “bill-by-the-hour” professionals to have access to various software programs for time management and client billing to keep track of client and personal activity. The terms “client” and “customer” are used throughout this specification and are meant to be construed essentially synonymously; that is to say, each refer to a person or entity for which a professional services provider renders professional services.

When assessing existing time management and client-billing programs, it is understandable that a consumer of such products and services might led to believe by vague generalities and the use of catch words or phrases such as “product marketing” to assume that one or more of such products may a panacea to time management and client billing problems.

In reality, presently available time management and client billing software applications are primarily based on “fill-in-the-blank”, pre-defined templates typically related to or incorporated in calendar applications that professional service providers populate to finalize a billing event. The pre-defined “fill-in-the-blank” templates can be populated on a desktop computer (stationary or portable) or a mobile device. However, presently available professional services billing programs do not permit a professional service provider to change billing rates or otherwise customize a communication event billing entry. Examples of such software include the following: Elite®—marketed by Thomson Reuters (West Publishing Corp.) Los Angeles, Calif.; Carpe Diem®, TimeSlips® and PeachTree® marketed by Sage Software Inc., Irvine, Calif.; CMS Open® marketed by Aderant North America, Tallahassee, Fla.; Omega Legal Systems® marketed by Omega Legal Systems, Inc., Phoenix, Ariz.; RainMaker® marketed by Rainmaker Software, Inc., BlueBell, Pa.; ProLaw® marketed by Thomson Reuters (West Publishing Corp.) Los Angeles, Calif.; Orion™ marketed by Orion Law Management Systems, Inc., Atlanta, Ga.; TABS3™ marketed by Software Technology, Inc., Irvine, Calif.;; DTEO Axiom™ marketed by Advanced Productivity Software Inc., Atlanta, Ga.; PCLaw™ and Juris® marketed by LexisNexis (Reed Elsevier Properties, Inc.) New York, N.Y.; QuickBooks® marketed by Intuit, Inc., Mountain View, Calif.; CompuLaw® marketed by CompuLaw Inc., Los Angeles, Calif.; and ESI Law marketed by ESI Software, Inc., North Vancouver, British Columbia, Canada.

Time management and client billing software companies often utilize manual entry of billable events on a computer. Certain of these companies offer a mobile “note pad” that mirrors the desktop version of their software, which can be synchronized to their computer at the user's office, desktop or portable computer. Examples include products marketed by Sage Software Inc., Aderant North America, Advanced Productivity Software Inc. and Rainmaker Software, Inc., noted above.

Additionally, most of these applications offer a “stopwatch” that is independent and unrelated to specific client case information. The case information needs to be manually entered or infused into a segment of the complete time capture process.

Typically, a stopwatch requires manual “start” and “stop” of the timer. Obviously, these applications are only as effective as the user's discipline and methods of time management in that a wristwatch can also achieve the same goal. Thus, if the user manually starts the timer and forgets to end it at the appropriate time, the billable time will be inaccurate and the professional will later have to use a “best guess” to record the time.

The software “stopwatch” is vulnerable to human error, i.e., if the stopwatch is started it can go on endlessly if the professional is away from his or her desktop. Additionally, stopwatches are product-specific. Further, if a user opens a second application the stopwatch is hidden in the first application and is unseen by the user. Accordingly, timekeeper intervention required to stop a timer is the weak variable that affects accurate time management. Unless the stopwatch is started and stopped at the precise moment an event is ended it will lead to inaccurate time entry and billing.

It is also common for time and billing software companies to reference mobile devices in their advertisements because most time and billing programs have a calendar element, which is transferred to a mobile device through daily synchronizing of the device and computer. Such “syncing” is a basic function of PDA devices whereby a person can have his or her personal computer calendar available as well on a mobile device.

Further, presently available time and billing software packages are designed with user permissions restrictions t h at enable only accounting or other back-office administrative personnel to modify a professional service provider's time-related communication event entries. Thus, the professional service provider may populate certain fill-in-the-blank fields on the front-office application and then send the filled-in entry to the back-office application which is managed by accounting or other administrative personnel. The back office personnel with appropriate permissions may then modify the entry.

### SUMMARY OF THE INVENTION

The system disclosed in the '065 application focuses specifically on capturing only professional services associated exclusively with mobile communications device phone calls. In contrast, the instant invention provides new technology and teaches new methods for capturing time events on mobile devices as well as desktop, laptop, notebook and other stationary and portable computers. More particularly, the present invention expands into capturing communication events including, without limitation, VOIP time, email events, video, audio and/or audiovisual messages, capturing of meeting and consultation time for professionals, sales appointments for sales professionals, service appointments for in-the-field service professionals, and the like, on mobile communications devices as well as stationary and portable computers as well as mobile devices such as cellular telephones, (PDAs), and the like. The invention further contemplates creation of archive or back-up repositories for any and all of the foregoing.

For instance, email and VoIP calls can now be captured along with their start time, end time and content. Additionally, a user has the ability to add notes and modify this information and other information so that it integrates properly with customer relationship management (CRM) software, contact management software, business management and billing packages, databases and the like.

Still further, appointments, meetings and consultations can also be logged as communication events while working in an office or other stationary or portable computer environment or while communicating on a mobile or VOIP connection. For example, a user may start a timer on his or her desktop, laptop or notebook computer while bringing up an account or client profile and capture the time spent with that client to create a bill or CRM event. The user can observe the elapsed time that reflects the time spent on the consultation or appointment, which time is concurrently logged on the mobile device or the computer. The user also has the ability to add notes and modify other pertinent content for a sales, service or billable event. The stationary or portable computer application would also have the ability to capture VOIP activity as well.

All versions of the instant application preferably incorporate automatic triggers and/or permit manual intervention to enable a user to capture and store events for review, planning, billing and the like. The stationary/portable version also has the ability to receive and send this content to the mobile version either directly or over the Internet so that there is a bi-directional synchronization of data.

In the stationary or portable version of the present system there is an option to fully automate the capture of designated communication events. Thus, when each event occurs, an automatic timer starts and a screen appears suitable for capturing the specific details, notes and modifications or customizations associated with each event. During each event a timer may be displayed on the screen indicating in real-time the time to be captured for each activity. The billable rate for a service professional (where applicable) would also accumulate in real-time for the duration of the activity as the user is typing, consulting, emailing on VOIP, or the like. If preferred by the user, the system can also be set up to operate in a manual mode instead of an automatic mode. In manual mode, all of the features can be implemented through manual input with some integration of automatic events.

In the mobile version as well as the stationary or portable versions, the ability to capture time spent on other events such as Internet time, gaming time, multimedia message time and text messaging time constitutes a considerable expansion beyond the previous feature set offered by the '065 application.

Unlike the '065 application, which focused solely on mobile device telephone calls for capturing bill-by-the-hour time and referencing a built-in (i.e., on-the-device) address book within the application, both the mobile and stationary/portable versions of the present invention may work on-the-device or interact with remote web-based data systems by both sending and retrieving data to bring contact and other information to the foreground on the mobile device's or computer's display screen via interactive windows and menus whereby such information may be uniquely customized by a professional services provider. This enables more efficient functionality and delivers significant benefits to the end user experience vis-à-vis the system disclosed in the '065 application.

An example embodying the invention is when a phone number is dialed and a network connection is established on a mobile device. In that event, a short message service (“SNS”) or “text” message is sent to a server which includes that phone number. The event is then triggered and brought forward on the device's display screen in real-time speed over the Internet with a timer concurrently running. The displayed screen then permits the user to add content directly into the back end office or desktop application.

Among other capabilities and, by way of example only, the present invention enables a user, when sending an email or other electronic communication, to capture the communication, its recipient, its start and end times, any associated notes that the user may want to include, and customize any of the foregoing and any billing related information the user may desire to input. The start and end times can be entered automatically or manually depending on which method most accurately captures the amount of time spent in creating the email before it was sent, such as—in the legal services context, for instance—discovery and research. The instant invention also offers the ability to mirror and/or copy the full email (or other communication type) when sent from the mobile device or computer for upload to a server, whereby the server's associated database(s) function as a back-up, mirror or archive system in the event the communication or its content is lost from the mobile device. Saving or archiving of data can be applied to any areas of interest such as, without limitation, telephone calls, appointments, consultations, emails and VOIP (for both mobile devices and stationary or portable computers), whereby all aspects of an electronic communication may be captured and saved to a file and to a specific client for future viewing and archive purposes.

Other details, objects and advantages of the present invention will become apparent as the following description of the presently preferred embodiments and presently preferred methods of practicing the invention proceeds.

### BRIEF DESCRIPTION OF THE DRAWINGS

The invention will become more readily apparent from the following description of preferred embodiments thereof shown, by way of example only, in the accompanying drawings wherein:

FIG. 1 illustrates a mobile communications device and an enlarged view of a display screen thereof depicting a communication event report generated by the software of a presently known telephone call management system;

FIG. 2 illustrates billing parameters that may be established by an operator using the software of the system of FIG. 1;

FIG. 3 illustrates typical management capabilities of new calls processed by the software of the system of FIG. 1;

FIG. 4 is an enlarged view of mobile communications device display screen illustrating certain call status identification parameters that may selected using software embodying the communication event management system according to the present invention;

FIG. 5 is an enlarged view of a mobile communications device display screen illustrating certain billing revenue capture parameters that may accessed using software embodying the communication event management system according to the present invention;

FIG. 6 is an enlarged view of a mobile communications device display screen illustrating certain communication event summary parameters that may accessed using software embodying the communication event management system according to the present invention;

FIG. 7 is an enlarged view of a mobile communications device display screen illustrating certain communication event and billing parameters that may accessed using software embodying the communication event management system according to the present invention;

FIG. 8 is a view of a display screen of a stationary or portable computer illustrating the first of a plurality of steps by which a user of the communication event management system according to the present invention may manually charge a customer or client for professional services; and

FIG. 9 is a view of a display screen of a stationary or portable computer illustrating a further one of a plurality of steps by which a user of the communication event management system according to the present invention may manually charge a customer or client for professional services.

### DETAILED DESCRIPTION OF THE INVENTION

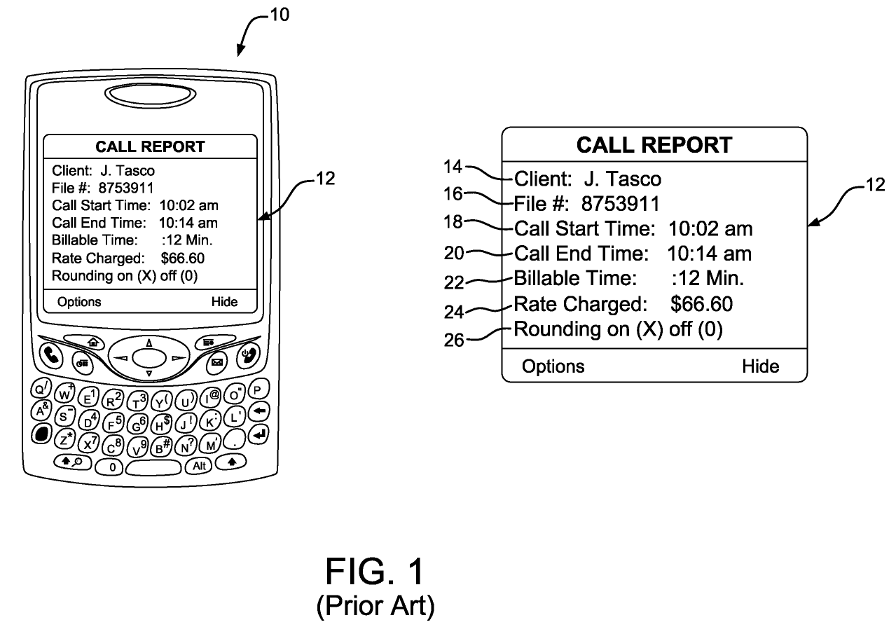

Referring to the drawings wherein like or similar references indicate like or similar elements throughout the several views, there is shown in FIG. 1 a mobile communications device 10 and an enlarged view of a display screen 12 thereof depicting a communication event report generated by the software of a presently known telephone call management system. The communication event software, is may be programmed directly into a cellular telephone, personal digital assistant (“PDA”) or other mobile communications device 10 or may reside on a remote server. As used herein, a “mobile communications device” means a pocket-sized, hand-held communications device with at least telephony capability and, preferably, at least text messaging functionality. It will be understood, however, that device 10 may also possess Web access and other capabilities available in presently-existing and hereinafter-developed, cellular telephones, PDAs and devices having similar characteristics and functionalities. In contrast, as used herein, a “stationary computer” means a computer which is essentially immobile (e.g., a personal computer or “PC” having peripherals—keyboard, mouse, etc. —that are intimately connected by hard wiring or short-distance wireless communication to a computing device which itself is connected by wire to a source of AC electricity) and a “portable computer” means a computer that, although “mobile” in the sense that it may be transported and used in many physical locations, is not typically “hand-held” or “pocket-sized” and normally requires the user to employ a stable site (including a user's lap or other body part) to support the computer in order to enable interaction of the user with the computer's primary user interface (typically a keyboard). Examples of such “portable computers” include presently known laptop and notebook computers. Hereinafter developed computers having similar characteristics and functionalities to the above-described mobile devices, stationary computer or mobile computers are also contemplated to be within the scope of the present invention.

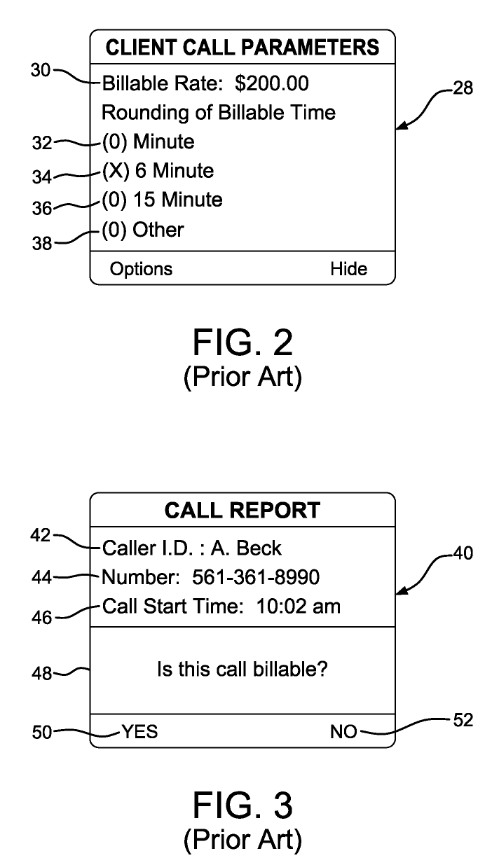

FIG. 1 illustrates views of a wireless communications device 10 having typical client telephone call management information displayed in its display screen 12. As is known, device 10 includes input keys including alphanumeric characters and function buttons, as well as telephonic functionality for enabling the user to interact with both the device and other persons or entities. Call management information (or “report”) fields that may be displayed on screen 12 may include: client 14, file number 16, call start time 18, call end time 20, billable time 22, professional services billing rate charged for the call 24, and time unit rounding “on” or “off” 26. Assuming the time unit rounding function of FIG. 1 is turned “on” by a user, the client call parameter screen 28 of FIG. 2 appears. Turning to FIG. 2, the program populates the display screen with the professional services provider's billing rate 30 (e.g., $200.00 per hour) as well as several user-selectable options for upwardly rounding the call time of a client or customer telephone call to a desired time increment (e.g., rounding to a fraction of an hour such as, for example, one minute (reference numeral 32), six minute or 1/10 hour (reference numeral 34), 15 minute or ¼ hour (reference numeral 36) or some other time increment (reference numeral 38).

FIG. 3 illustrates a display screen 40 presented by a mobile device implementing the system of the '065 application for processing calls received by the mobile communications device 10. In screen 40, Caller I.D. 42 and telephone number 44 are displayed along with call start time 46. In section 48 the user is queried “Is this call billable?” or word(s)/symbol(s) of similar effect which are displayed when a new call event is received. The user is then presented with the option of capturing the new call event by pressing a mobile communications key corresponding to either the decision “YES” 50 or “NO” 52. If “YES” is selected the call event is captured. Likewise, if “NO” is selected the call event is not captured. If the incoming phone number is recognized by the software as existing in the user's address book the following information from FIG. 1 appears: client 14, file number 16, call start time 18, call end time 20, billable time 22, rate charged 24, and time rounding 26. The foregoing information is also displayed and capture options are presented if the user places an outgoing call to a pre-existing client. If the incoming call is not a pre-existing entry in the device's address book or database the user is presented with Caller I.D. 42, telephone number 44 and call start time 46 at screen 40 at which time the user is queried “Is this call billable?” or word(s)/symbol(s) of similar effect and selects either “YES” or “NO”. At completion of any call event, the user may opt to enable the call data to either remain on screen 40 until the next call event occurs or hide the data from view by selecting “NO”.

As is known in the art, the telephone call management system software program of the prior art or the “communication event” software of the present invention (discussed below) may be installed on a mobile communications device by direct cable connection between the mobile device and a computer which is loaded with the desired program that is to be installed on the mobile device. Alternatively, as is also known, the program may be installed by a wireless system employing for example, cellular towers and/or satellites.

Similar to that described in the '065 application, set-up and integration of the software of the present invention with a mobile communications device is generally as follows. Initially, a professional services provider's client database is entered into the software program which information is, in turn, copied to the professional's mobile device. As used herein a “professional services provider” may be a legal, medical, engineering, contract, sales, or any other provider of professional services whose time is normally recorded for billing purposes. All client file management is preferably backed-up on a separate server. Additionally, a professional service provider's client billing information preferably synchronizes the mobile device's recorded billing data with his/her firm's or office's client billing program.

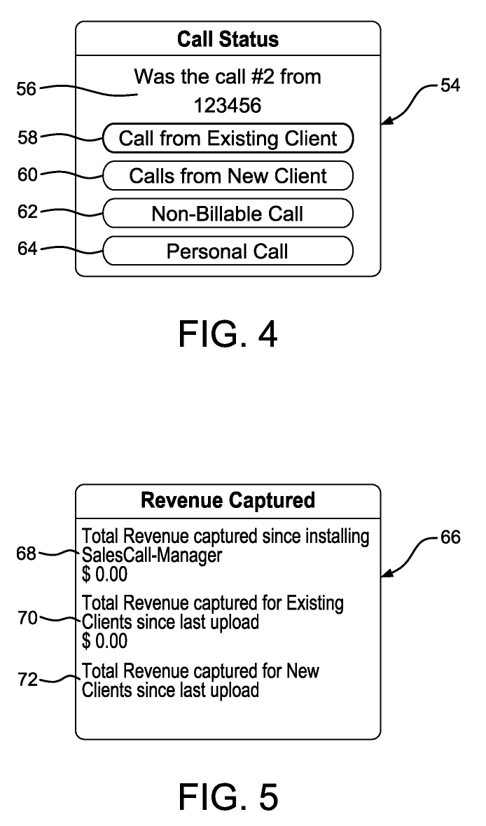

FIG. 4 reveals features of the communication event management system according to the present invention which represents a substantial improvement to the system described in connection with FIGS. 1-3. More particularly, FIG. 4 depicts a call status display screen 54 which queries the user to verify at section 56 from which telephone number an incoming call originates. Screen 54 also provides the user with several options for classifying the call: that is, option 1 (reference numeral 58), is the call from an existing client; option 2 (reference numeral 60), is the call from a new client; option 3 (reference numeral 62), is the call non-billable; and option 4 (reference numeral 64), is the call a personal call.

FIG. 5 reveals additional features of the communication event management system according to the present invention. More particularly, FIG. 5 depicts a call revenue capture screen 66 which provides the user with several options for accessing revenue capture information realized as a result of implementation of the instant system: that is, option 1 (reference numeral 68), the total revenue captured since installing the system; option 2 (reference numeral 70), the total revenue captured for existing clients since last upload; option 3 (reference numeral 72), and the total revenue captured for new clients since last upload. It will be appreciated that, in addition to the foregoing, the software of the present communication event management system may be configured to provide the user with any desired type or class of revenue capture information.

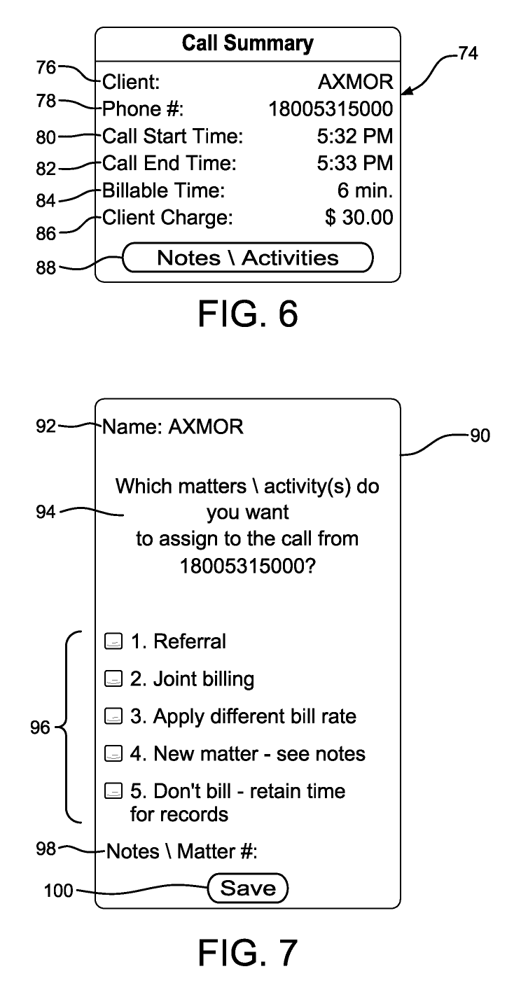

FIG. 6 reveals a call summary display screen 74 according to the present invention which is similar to call report screen 12. That is, for a particular call event, screen 74 provides a user with such information as the client name 76, telephone number 78, call start time 80, call end time 82, billable time 84 and amount charged for the call 86. Additionally, screen 74 preferably includes an actuatable button 88 containing the terms “notes/activities” or word(s)/symbol(s) of similar effect which, when actuated, invokes a screen 90 that enables a user, in addition to assigning a telephone call or other communication event (e.g., an email, a text message, or the like) to a particular customer or client account, many additional ways and means by which information associated with the event, including billing information, may be customized to the user's needs or desires.

More specifically, screen 90 preferably includes at 92 the name of the client/customer and, at 94, queries the user to which matters/activities the user desires to assign the event. In addition, as indicated by reference numeral 96, the notes/activities screen 90 also preferably offers the user with the opportunity to customize characteristic information associated with a communication event. Such information may not include any one or more those shown in FIG. 7 or may include any other additional unillustrated data that may be of value to a particular user and/or for a particular profession.

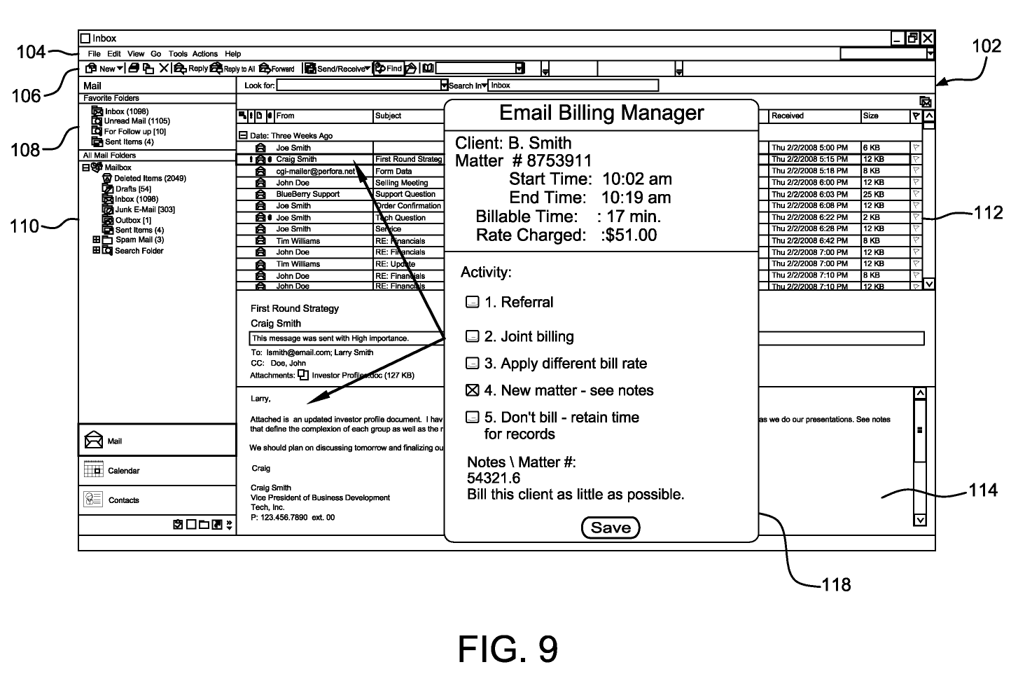

By way of example, but not limitation, such customizable information may include whether (1) the client/customer of the user came to the user by way of referral, (2) the event should be jointly billed to more than one client, account, matter, etc., (3) a professional services billing rate other than the user's standard billing rate should be applied to the event, (4) the event pertains to a new matter, and (5) the event should not be billed, but still retained for records purposes. Screen 90 further desirably includes a Notes/Matter# section 98 which enables a user to input notes relating to the event (an example of such notes is provided in FIG. 9, discussed below). Once the user is satisfied with the customized information input into screen 90, he or she actuates “SAVE” button 100 to store the information on the device or on a remote server. In this regard, if the call event information (including any customizable information) is stored on the device, the device is typically periodically manually or, more preferably, automatically synchronized with a remote server whereby the remote server not only provides back-up archival storage of the communication events but also communicates with the office's back end billing software whereby bills or invoices are generated which contain the customized billing information input by the user. This is in contrast with currently available professional services billing programs which merely permit the user to introduce information into predefined client identification, time expended, and “narrative” fields to describe his or her activities associated with a particular communication event. Stated differently, the present invention enables a user to customize billing rate, referral source, matter and other information associated with a communication event whereas existing billing programs merely permit a user to populate—but not customize—a very limited and predetermined set of information fields.

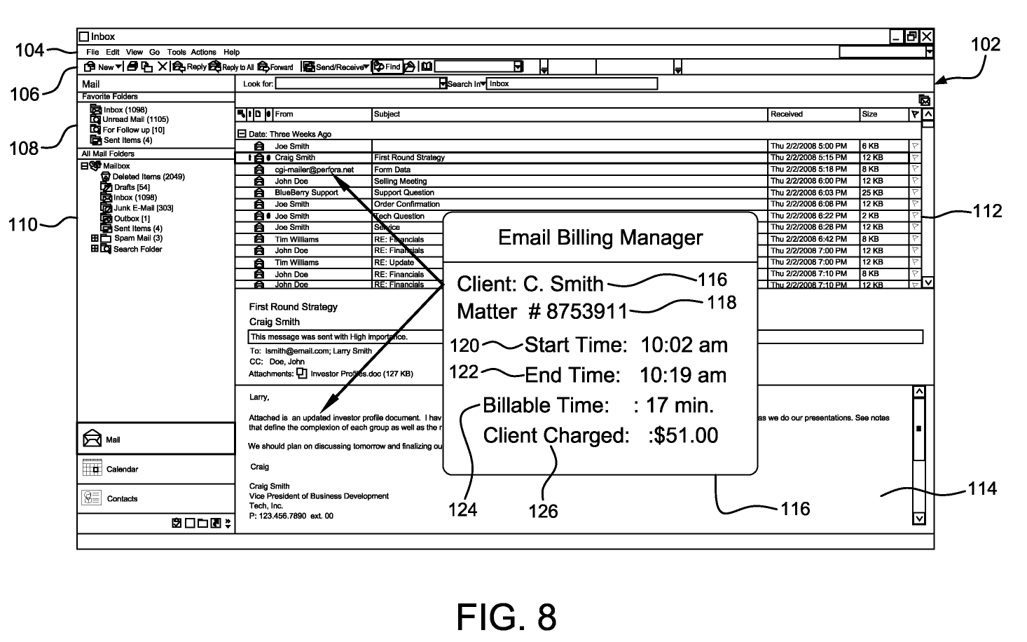

As thus far disclosed, the communication event management system according to the invention has been described and illustrated as it would be implemented on a mobile communications device whose screen display area is relatively small. Because of this spatial limitation, however, the amount of information that can be displayed on a mobile device at any given time is proportionately limited. As will be seen in FIGS. 8 and 9, the instant communication event management system may also be implemented on a stationary or mobile computer whose display screen area is generally considerably larger and can support and display a proportionately greater amount of information at any given time.

As seen in FIG. 8, a typical “desktop”, “laptop” or notebook” email “inbox” display screen is identified generally by reference numeral 102. Such screen is analogous to “sent” emails, VOIP communications, text messages, multimedia messages or any other types of messages that can be sent or received by a portable or stationary computer (or mobile device). Screen 102 may include such typical information as toolbars 104, 106 as well as folders 108, 110. Within the central region of screen 102 there is typically a list 112 of the user's most recently received emails as well as an enlarged screen 114 showing the content of a particular email message selected in screen 112. In addition, there is presented in the foreground of the screen a window 116 which may contain items of information described above in connection with FIG. 6, e.g., client name 116, matter number 118, email start time 120, email end time 122, billable time 124 and amount charged for the call 126.

Similarly, FIG. 9 illustrates the “email” counterpart to the telephonic (call) communication event information recordation diagram shown in FIG. 7. That is, in addition to inbox display screen 102, toolbars 104, 106, folders 108, 110, email list 112 and enlarged selected email screen 114, FIG. 9 includes a screen 118 which may include some of, all, none or more than the customizable communication event characteristic information shown and described in connection with FIG. 7.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. A professional services time capturing system comprising:
at least one of a stationary computer, a portable computer and a mobile communications device; and
a software application executable on said at least one of a stationary computer, a portable computer and a mobile communications device for capturing professional services time, said software application including:
means for enabling a professional service provider to assign time to at least one client account for a communication event, and
means for enabling a professional service provider to customize information associated with a billing entry corresponding to a communication event prior to submission of the billing entry to a back-office billing application.

2. The system of claim 1 further comprising a remote server for supporting said software application and for storing time-related information entered by a professional services provider on said at least one of a stationary computer, a portable computer and a mobile communications device.

3. The system of claim 2 further comprising means for synchronizing said remote server with said at least one of a stationary computer, a portable computer and a mobile communications device.

4. The system of claim 1 wherein said means for enabling permits a professional services provider to customize, prior to submission to a back-office billing application, information selected from the group including: a wireless cell phone call, an email message, an instant messaging message, a voice over internet protocol (“VOIP”) call, a video, audio and/or audiovisual message, an appointment, a meeting and a consultation.

5. A professional services call capturing system comprising:
at least one of a stationary computer, a portable computer and a mobile communications device; and
a software application executable on said at least one of a stationary computer, a portable computer and a mobile communications device for capturing professional services time, said software application including:
means for querying a professional services provider to verify a telephone number from which an incoming call originates; and
means for providing a professional services provider options for classifying the incoming call, including: whether the call is from an existing client; whether the call is from a new client; whether the call is non-billable; and whether the call is a personal call.
